(19) United States
(12) Patent Application Publication
(10) Pub. No.: US 2026/0175670 A1
(43) Pub. Date: Jun. 25, 2026

(54) VEHICLE

(71) Applicant: SUBARU CORPORATION, Tokyo (JP)

(72) Inventors: Hiroshi SHIMAKATA, Tokyo (JP); Takuya ARAI, Tokyo (JP); Katsuo KOBAYASHI, Tokyo (JP)

(21) Appl. No.: 19/410,520

(22) Filed: Dec. 5, 2025

(30) Foreign Application Priority Data
Dec. 25, 2024 (JP) 2024-228901

(51) Int. Cl. B60K 7/00

(52) U.S. Cl. CPC B60K 7/0007; B60K 2007/0092

(57) ABSTRACT

A vehicle includes a wheel, a rotor, and a stator. The wheel is provided in a wheel space that opens in a side surface of a body. The rotor is provided in an internal space of a rim of the wheel. The stator includes a blocking plate configured to block the internal space. The rotor includes rotating vanes arranged along a rim surface of the rim. The rotating vanes cause air in a central region of the wheel to flow toward the rim surface when the wheel rotates in a forward direction. The stator includes a hollow cylinder and an exhaust nozzle. The hollow cylinder projects outward from the blocking plate and is interposed between the rim surface and the rotating vanes. The exhaust nozzle has an opening in the blocking plate, is disposed on an inner surface of the blocking plate, and extends rearward from the opening.

### CROSS-REFERENCE TO RELATED APPLICATIONS

The present application claims priority from Japanese Patent Application No. 2024-228901 filed on Dec. 25, 2024, the entire contents of which are hereby incorporated by reference.

### BACKGROUND

This application mainly discloses a vehicle.

Japanese Unexamined Patent Application Publication (JP-A) No. 2022-091511 discloses a wheel with the entire outer surface formed in the shape of a screw.

### SUMMARY

An aspect of the disclosure provides a vehicle including a wheel, a rotor, and a stator. The wheel is provided in a wheel space that opens in a side surface of a body of the vehicle. The wheel is rotatable. The rotor is provided in an internal space of a rim of the wheel. The rotor is rotatable with the wheel. The stator includes a blocking plate configured to block the internal space. The rotor includes a plurality of rotating vanes arranged along a rim surface of the rim. The rotating vanes cause air in a central region of the wheel to flow toward the rim surface when the wheel rotates in a forward direction. The stator includes a hollow cylinder and an exhaust nozzle. The hollow cylinder projects outward in a vehicle width direction from the blocking plate and is interposed between the rim surface and the rotating vanes. The exhaust nozzle has an opening in the blocking plate. The exhaust nozzle is disposed on an inner surface of the blocking plate in the vehicle width direction and extends rearward relative to the body from the opening.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a schematic left side view illustrating the flow of air around a body of a moving vehicle;

FIG. 2 is a schematic bottom view illustrating the flow of air under the body illustrated in FIG. 1;

FIG. 3 is a schematic vertical sectional view of a structure including a left front tire and wheel on a vehicle according to an embodiment of the disclosure;

FIG. 4 is a schematic horizontal sectional view of the structure including the left front tire and wheel illustrated in FIG. 3;

FIG. 5 is a schematic left side view of a stator illustrated in FIG. 3;

FIG. 6 is a schematic left side view of a rotor illustrated in FIG. 3;

FIG. 7 is a schematic top view of the rotor illustrated in FIG. 6;

FIG. 8 is a schematic left side view illustrating the flow of air around a body of the vehicle according to the embodiment of the disclosure;

FIG. 9 is a schematic bottom view illustrating the flow of air under the body illustrated in FIG. 8; and

FIG. 10 is a schematic top view of a rotor according to a modification of the embodiment of the disclosure.

### DETAILED DESCRIPTION

A vehicle may generate outflow from rotating wheels exposed at side surfaces of the body of the vehicle while moving. The outflow disturbs airflow in a front-to-rear direction along the side surfaces of the body. The disturbances of the airflow increase the air resistance on the body.

The outflow from the wheels may be reduced by, for example, shaping the entire outer surfaces of the wheels to be flat. JP-A No. 2022-091511 discloses a wheel with the entire outer surface formed in the shape of a screw.

However, when the entire outer surfaces of the wheels are limited to flat surfaces, for example, the design of the wheels and the body is significantly limited. Reducing the height or size of wheel spaces in the body also imposes a limitation on the design of the body, and may lead to noncompliance with regulations in some countries. The outflow from the wheels may also be reduced by forming an air curtain between each wheel space and the space outside the wheel space by placing fenders or the like having an air curtain function around the wheel spaces. However, such a fender has not yet been installed on an actual vehicle.

It is desirable to reduce the air resistance on the body of the vehicle by reducing the outflow from the wheels without limiting the design of the wheels and the body.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

A summary of the embodiment will be described first, and then the flow of air around the body of a vehicle, the structure for reducing outflow from wheels, the structure of a stator, the structure of a rotor, and examples of the effects will be described.

### SUMMARY

When a vehicle moves, an airflow under the body of the vehicle may partially flow outward from the side surfaces of the body through wheels disposed in wheel spaces and exposed at the side surfaces of the body. Thus, the air resistance on the entire body is increased.

To address this, according to an embodiment of the disclosure, a rotor and a stator are provided. The rotor is in an internal space of a wheel and is rotatable with the wheel. The stator includes a blocking plate that blocks the internal space. The rotor includes rotating vanes. The rotating vanes are arranged along a rim surface of a rim of the wheel, and cause air in a central region of the wheel to flow toward the rim surface when the wheel rotates in a forward direction. The stator includes a hollow cylinder and an exhaust nozzle. The hollow cylinder projects outward in a vehicle width direction from the blocking plate and is interposed between the rim surface and the rotating vanes. The exhaust nozzle has an opening in the blocking plate. The exhaust nozzle is disposed on an inner surface of the blocking plate in the vehicle width direction and extends rearward relative to the body from the opening.

Thus, according to the embodiment of the disclosure, the outward airflow through the internal space of the wheel can be reduced, and air in the internal space of the wheel can be caused to flow into the space under the body. As a result, the air resistance on the body of the vehicle according to the embodiment of the disclosure is expected to be reduced. According to the embodiment of the disclosure, the air resistance on the body can be reduced by reducing the outflow from the wheel without limiting the shape of the wheel itself.

### Example of Flow of Air Around Vehicle Body

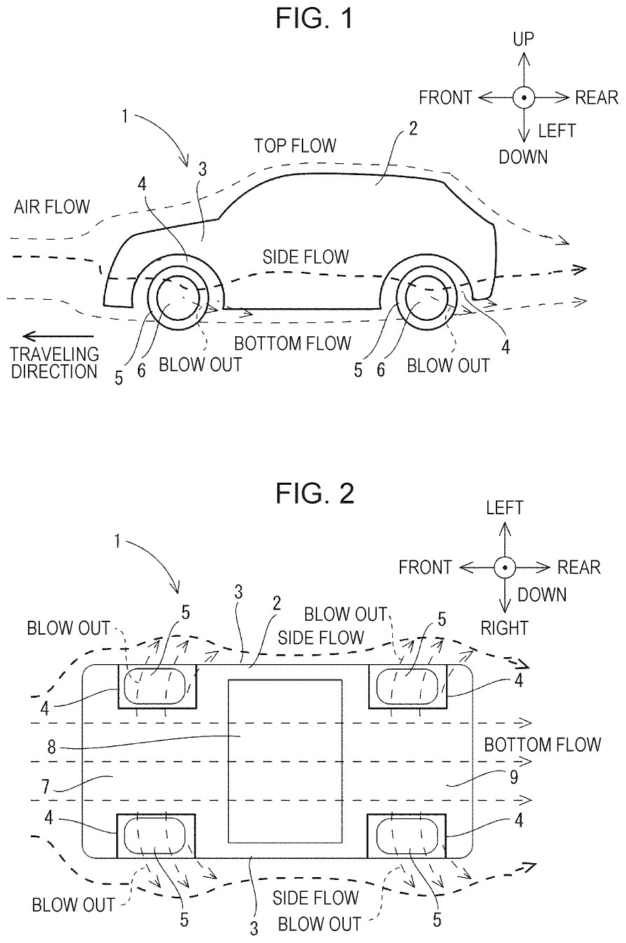

FIG. 1 is a schematic left side view illustrating the flow of air around a body 2 of a moving vehicle 1. FIG. 2 is a schematic bottom view illustrating the flow of air under the body 2 illustrated in FIG. 1.

As represented by the dashed lines in FIGS. 1 and 2, when the vehicle 1 moves, the flow of air in a front-to-rear direction relative to the body 2 is generated around the body 2. The flow of air generates air resistance on the body 2. The air hits the front surface of the body 2, and then splits in the up, down, left, and right directions into flows along the top, bottom, left and right surfaces of the body 2, which merge behind the body 2. FIGS. 1 and 2 illustrate a top airflow above the body 2 (top flow), a bottom airflow under the body (bottom flow), and side airflow along the side surfaces of the body (side flow). The air resistance on the body 2 can be reduced by allowing air to flow smoothly along the surfaces of the body 2 and to flow without being separated from the surfaces of the body 2. Manufacturers study the shapes of the body 2 to improve the fuel efficiency or electric power efficiency.

In the following description, the terms “up”, “down”, “left”, “right”, “front”, and “rear” are used with reference to the directions illustrated in FIG. 1. The terms “inward” and “outward” are defined with respect to the center in the vehicle width direction. The outward direction is the direction away from the center in the vehicle width direction, and the inward direction is the direction toward the center in the vehicle width direction.

The extent to which air resistance on the body 2 can be reduced is limited. For example, the vehicle 1 includes pairs of tires 5 and wheels 6 that rotate in a forward direction to move the vehicle 1. To reduce vertical movement of the body 2 while the vehicle 1 is moving, the vehicle 1 includes suspensions 10 disposed between the body 2 and members under the axle, such as the tires 5 and the wheels 6. Accordingly, spaces for movement are to be provided below the body 2 and in wheel spaces 4. In addition, there are regulations for the ground clearance of the body 2. Therefore, the bottom airflow under the body 2 illustrated in FIG. 2 cannot be eliminated. The body 2 has multiple wheel spaces 4. The wheel spaces 4 are arranged in the front-rear direction at each of the left and right sides of the body 2 in the vehicle width direction. Each wheel space 4 opens in a side surface of the body 2.

In recent years, the body 2 of the vehicle 1 has been formed to have a flat bottom surface. A front under cover 7, a rear under cover 9, and a battery pack 8 between the front and rear under covers 7 and 9 are provided on the bottom surface of the body 2 illustrated in FIG. 2. When the bottom of the body 2 is flat, the velocity of the bottom airflow under the body 2 increases.

The bottom airflow partially flows outward in the vehicle width direction of the body 2 from the rotating wheels 6 exposed at the side surfaces 3 of the body 2 and the wheel spaces 4, generating outflow from the side surfaces 3 of the body 2. The outflow (blow out) disturbs the side airflow in the front-to-rear direction along the side surfaces 3 of the body 2 (side flow). Accordingly, the side airflow of the vehicle 1 cannot easily flow along the side surfaces 3 of the body 2. The disturbances of the airflow increase the air resistance on the body 2.

The outflow from the wheels 6 may be reduced by, for example, shaping the entire outer surfaces of the wheels 6 to be flat. However, when the entire outer surfaces of the wheels 6 are limited to flat surfaces, for example, the design of the wheels 6 and the body 2 is significantly limited.

Reducing the height or size of the wheel spaces 4 in the body 2 also imposes a limitation on the design of the body 2, and may lead to noncompliance with regulations in some countries.

The outflow from the wheels 6 may also be reduced by forming an air curtain between each wheel space 4 and the space outside the wheel space 4 by placing fenders or the like having an air curtain function around the wheel spaces 4. However, such a fender has not yet been installed on an actual vehicle.

It is desirable to reduce the air resistance on the body 2 of the vehicle 1 by reducing the outflow from the wheels 6 without limiting the design of the wheels 6 and the body 2.

### Example of Structure for Reducing Outflow From Wheels

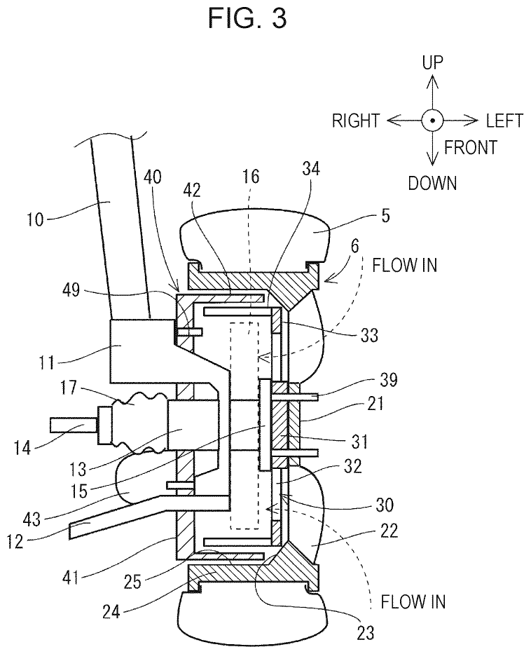

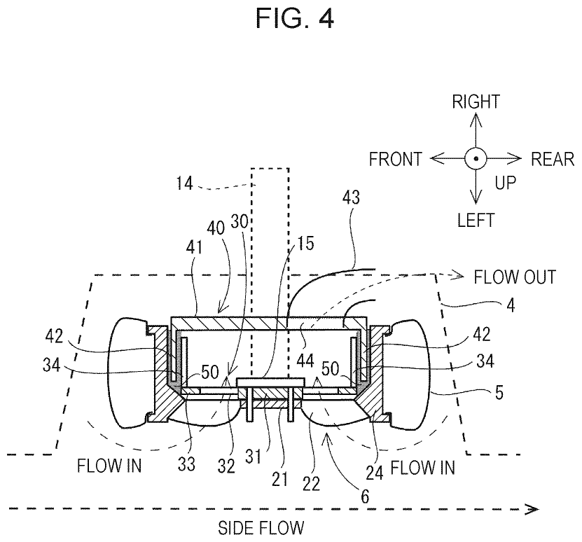

FIG. 3 is a schematic vertical sectional view of a structure including a left front tire 5 and wheel 6 on the vehicle 1 according to the embodiment of the disclosure. FIG. 4 is a schematic horizontal sectional view of the structure including the left front tire 5 and wheel 6 illustrated in FIG. 3. The tire 5 and the wheel 6 constitute a tire-wheel assembly.

A structure including a right front tire 5 and wheel 6 on the vehicle 1 is obtained by inverting the structure illustrated in FIGS. 3 and 4. A structure including a left rear tire 5 and wheel 6 on the vehicle 1 and a structure including a right rear tire 5 and wheel 6 on the vehicle 1 may also be basically similar to the structure illustrated in FIGS. 3 and 4.

As illustrated in FIGS. 3 and 4, the vehicle 1 includes a knuckle arm 11, which is a support for supporting the tire-wheel assembly including the tire 5 and the wheel 6. The knuckle arm 11 is attached to a lower arm 12 and a suspension 10, and is thereby supported by the body 2. The lower arm 12 is attached to a framework member of the body 2 in a swingable manner. The suspension 10 is attached to a framework member of the body 2. The suspension 10 is attached to an upper portion of the knuckle arm 11 in a swingable manner. The lower arm 12 is attached to a lower portion of the knuckle arm 11 in a swingable manner. The knuckle arm 11 is supported by the body 2 such that the entirety thereof is vertically movable. The knuckle arm 11 is coupled to a steering rod (not illustrated) and changes the orientation thereof relative to the body 2 in response to a movement of the steering rod in the vehicle width direction. Accordingly, the orientation of the tire 5 and the wheel 6 changes relative to the vehicle 1, thereby changing the moving direction of the vehicle 1.

For the rear tires 5 and wheels 6, which are not steered, the respective knuckle arms 11 are not coupled to the steering rod. Each of the knuckle arms 11 for the rear tires 5 and wheels 6, which are not steered, may be attached to the lower arm 12 and an upper arm. In this case, the suspension 10 is attached to the upper arm.

Each knuckle arm 11 has a hole through which a hub member 13 extends in a rotatable manner. The hole extends in the vehicle width direction. An end of the hub member 13 that projects inward beyond the knuckle arm 11 is coupled to a drive shaft 14 with a universal joint 17. A hub plate 15 is provided on an end of the hub member 13 that projects outward beyond the knuckle arm 11. Wheel screws 39 are disposed to extend from the hub plate 15. As represented by the dashed lines in FIG. 3, a brake disc 16 is disposed on a portion of the hub member 13 between the hub plate 15 and the knuckle arm 11. The brake disc 16 is fixed to the hub member 13.

The wheel 6 includes a substantially cylindrical rim 24, a hub 21 that is concentric with the rim 24, and spokes 22 that couple the rim 24 to the hub 21. The hub 21 has screw holes through which the wheel screws 39 can be inserted. The hub 21 of the wheel 6 is placed on the hub plate 15 and attached to the body 2 with the wheel screws 39 and wheel nuts (not illustrated). The wheel 6 is rotatable about an axis of the hub 21 together with the hub member 13.

In the wheel 6 illustrated in FIGS. 3 and 4, the spokes 22 have the shape of radially extending rods. The spokes 22 constitute an outer design surface of the wheel 6. The spokes 22 may have shapes other than the shape of radially extending rods. The spokes 22 may have any shape that matches the design of the body 2.

The tire 5 is attached to the outer periphery of the substantially cylindrical rim 24. The wheel 6 and the tire 5 constitute a tire-wheel assembly.

According to the above-described structure, the wheel 6 and the tire 5 are disposed in the wheel space 4 on the side surface 3 of the body 2. The wheel 6 and the tire 5 are rotatably disposed in the wheel space 4 and exposed at the side surface 3 of the body 2 of the vehicle 1.

The brake disc 16, the hub member 13, and other components are disposed in an internal space of the substantially cylindrical rim 24 of the wheel 6.

In the present embodiment, a rotor 30 and a stator 40 are provided in the internal space of the wheel 6.

### Example of Structure of Stator

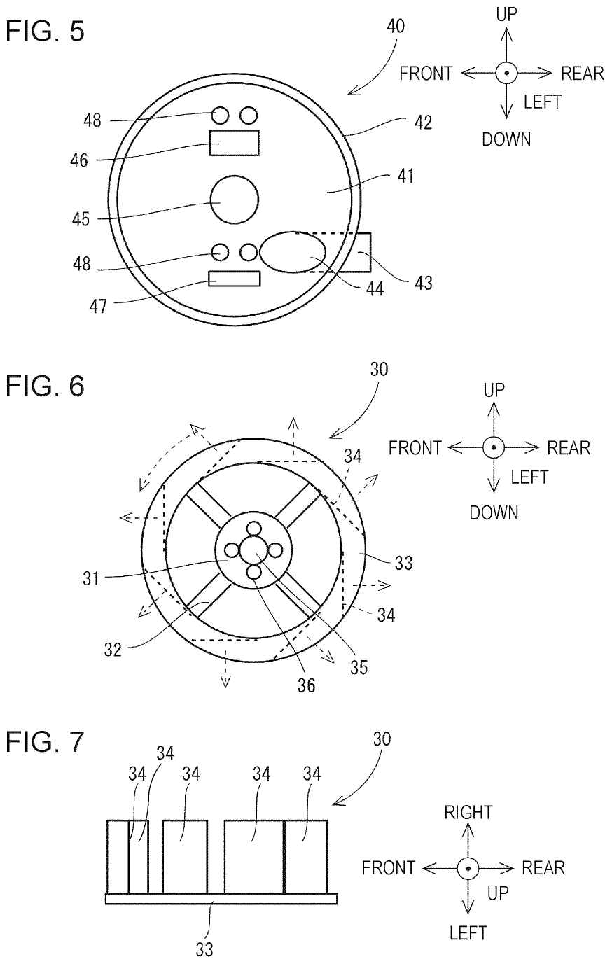

FIG. 5 is a schematic left side view of the stator 40 illustrated in FIG. 3.

The stator 40 includes a blocking plate 41, a hollow cylinder 42, and an exhaust nozzle 43. The stator 40 is disposed in the internal space of the wheel 6 and blocks the internal space of the wheel 6 from the inner side. The stator 40 is capable of causing the air in the internal space of the wheel 6 to flow into the space under the body 2 through the exhaust nozzle 43.

As illustrated in FIGS. 3 and 4, the blocking plate 41 is a disc-shaped plate that is slightly smaller than the substantially cylindrical rim 24 of the wheel 6. The blocking plate 41 has a hub hole 45, a lower arm hole 47, a knuckle arm hole 46, and fixing holes 48. The hub hole 45 is at the center of the blocking plate 41. As illustrated in FIGS. 3 and 4, the blocking plate 41 is fixed to the knuckle arm 11 with fixing screws inserted through the fixing holes 48 while the knuckle arm 11 is inserted through the knuckle arm hole 46, the lower arm 12 is inserted through the lower arm hole 47, and the hub member 13 is inserted through the hub hole 45. When the blocking plate 41 is fixed to the knuckle arm 11, the hub hole 45, the lower arm hole 47, the knuckle arm hole 46, and the fixing holes 48 are substantially blocked.

The hollow cylinder 42 is provided along the circumference of the blocking plate 41, which is a disc-shaped plate. The hollow cylinder 42 projects outward from the blocking plate 41 in the vehicle width direction. When the blocking plate 41 is fixed to the knuckle arm 11, the hollow cylinder 42 is positioned in the internal space of the substantially cylindrical rim 24 of the wheel 6. The hollow cylinder 42 of the stator 40 is disposed in the internal space such that a small gap 50 is provided between the stator 40 and a rim surface 25 of the rim 24 of the wheel 6.

The stator 40 having the above-described structure blocks the internal space of the wheel 6 from the inner side in the vehicle width direction of the body 2. Thus, the internal space of the wheel 6 and the space below the body 2 on the inner side of the wheel 6 can be separated from each other such that airflow cannot easily pass therebetween. Airflow is not easily generated from the space on the inner side of the internal space of the wheel 6 in the vehicle width direction toward the internal space of the wheel 6.

The exhaust nozzle 43 is provided on the inner surface of the blocking plate 41 of the stator 40 in the vehicle width direction. The exhaust nozzle 43 has an opening 44 in the blocking plate 41. The exhaust nozzle 43 extends rearward from the opening 44 in the blocking plate 41. Thus, the internal space of the wheel 6 and the space under the body 2 communicate with each other through the exhaust nozzle 43. When the vehicle 1 is moving, the bottom airflow under the body 2 flows in the front-to-rear direction relative to the body 2. The air pressure at the exit of the exhaust nozzle 43 extending rearward is reduced by the bottom airflow under the body 2 in the front-to-rear direction. As a result, the exhaust nozzle 43 can cause the air in the internal space of the wheel 6 to flow to the space under the body 2.

The opening 44 of the exhaust nozzle 43 in the blocking plate 41 is positioned behind and below the hub hole 45. When the opening 44 of the exhaust nozzle 43 is below the hub hole 45, the structure members of the body 2 are unlikely to be disposed behind the exhaust nozzle 43. The air discharged from the exhaust nozzle 43 to the space under the body 2 smoothly flows along the bottom surface of the body 2 toward the rear of the body 2. Such an exhaust environment may conceivably be achieved when the opening 44 of the exhaust nozzle 43 in the blocking plate 41 is below the shaft of the wheel 6.

When the vehicle 1 is moving forward, the air in the internal space of the wheel 6 more easily accumulates in a rear region than in a front region of the wheel 6. When the opening 44 of the exhaust nozzle 43 is positioned behind the shaft of the wheel 6, it can be expected that the air pressure around the opening 44 of the exhaust nozzle 43 in the blocking plate 41 will increase. When the difference between the air pressure around the opening 44 in the blocking plate 41 and the air pressure under the body 2 increases, the exhaust nozzle 43 can cause the air in the internal space of the wheel 6 to efficiently flow to the space under the body 2.

### Example of Structure of Rotor

FIG. 6 is a schematic left side view of the rotor 30 illustrated in FIG. 3. FIG. 7 is a schematic top view of the rotor 30 illustrated in FIG. 6.

The rotor 30 includes a center member 31, an annular member 33, couplers 32, and rotating vanes 34. The rotor 30 is disposed in the internal space of the wheel 6 such that the rotor 30 is inside the stator 40. The rotor 30 rotates together with the wheel 6 and generates radial airflow with the rotating vanes 34.

The center member 31 is a disc of the rotor 30 placed on the inner side of the hub 21 of the wheel 6 and fastened to the hub plate 15 of the body 2 together with the hub 21. The center member 31 has a hub hole 35 and fixing holes 36. The hub hole 35 is formed in the center member 31 so as to be concentric with the center member 31. The fixing holes 36 are formed around the hub hole 35 such that the wheel screws 39 are insertable therethrough.

The annular member 33 is an annular plate with an outer diameter less than that of the disc-shaped blocking plate 41.

The couplers 32 are rod-shaped. The couplers 32 couple the center member 31 to the annular member 33.

The annular member 33 is provided around the center member 31 so as to be coaxial with the center member 31.

The center member 31, the annular member 33, and the couplers 32 may be formed from a single plate by stamping, and thereby be permanently affixed to each other.

The rotating vanes 34 are arranged in an annular direction on the inner surface of the annular member 33 in the vehicle width direction. Each rotating vane 34 has the shape of a substantially rectangular plate. Each rotating vane 34 is supported by the annular member 33 in a cantilever manner at an edge of the substantially rectangular plate.

At the position at which each rotating vane 34 is attached to the annular member 33, the rotating vane 34 extends from the position of contact with a predetermined rotation circle, along which the rotating vane 34 rotates together with the annular member 33, in a tangential direction of the rotation circle. The rotating vane 34 may, for example, be shaped to have a flat plate-shaped cross section.

The rotating vanes 34 are disposed in the internal space of the wheel 6 when the center member 31 of the rotor 30 is placed between the hub 21 of the wheel 6 and the hub plate 15 of the body 2 and fastened together with the hub 21 of the wheel 6. The rotating vanes 34 are arranged along the rim surface 25 of the substantially cylindrical rim 24 of the wheel 6 in the internal space of the wheel 6. The hollow cylinder 42 of the stator 40 is interposed between the rim surface 25 of the wheel 6 and the rotating vanes 34. The hollow cylinder 42 of the stator 40 is spaced by small gaps from the rim surface 25 of the wheel 6 and the rotating vanes 34.

When the center member 31 of the rotor 30 is placed on the hub 21 and fastened to the hub plate 15 of the body 2 together with the hub 21, the entire circumference of the annular member 33 is in contact with an inner surface 23 of the wheel 6 that faces the internal space. The entire circumference of the annular member 33 is in contact with the inner surface 23 of the wheel 6 in a region of the wheel 6 in which the substantially cylindrical rim 24 is coupled to the spokes 22. The inner surface 23 faces the internal space of the wheel 6. Thus, the space around the hollow cylinder 42 of the stator 40 shaded in FIG. 4 is separated from the space outside the wheel 6. When the wheel 6 rotates in the forward direction, the rotating vanes 34 cause the air in a central region of the internal space of the wheel 6 to flow toward the rim surface 25, thereby increasing the air pressure in the space around the hollow cylinder 42 of the stator 40.

As described above, the center member 31 of the rotor 30 is placed on the inner side of the hub 21 of the wheel 6 and fastened to the hub plate 15 of the body 2 together with the hub 21. The rotor 30 is rotatable with the wheel 6.

The hollow cylinder 42 of the stator 40 fixed to the knuckle arm 11 of the body 2 is disposed between the rim surface 25 of the wheel 6 and the rotating vanes 34 of the rotor 30 in a non-rotatable manner. The rotating vanes 34 of the rotor 30 rotate on the inner side of the hollow cylinder 42 of the stator 40, which does not rotate together with the wheel 6, and the rim 24 of the wheel 6 rotates on the outer side of the hollow cylinder 42. The air pressure in the gap 50 between the hollow cylinder 42 of the stator 40 and the rotating vanes 34 of the rotor 30 may be increased due to the radial airflow generated by the rotating vanes 34. The air pressure in the gap 50 between the hollow cylinder 42 of the stator 40 and the rim 24 of the wheel 6 can be expected to increase. When the air pressure in the gap 50 between the hollow cylinder 42 of the stator 40 and the rim 24 of the wheel 6 increases, air does not easily flow through the gap 50.

### Effects

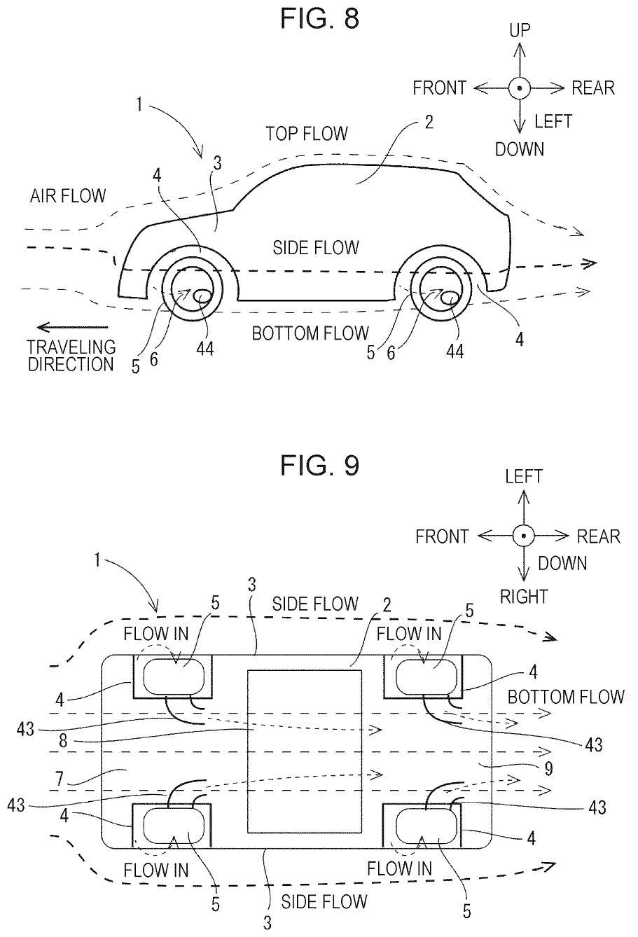

FIG. 8 is a schematic left side view illustrating the flow of air around the body 2 of the vehicle 1 according to the embodiment of the disclosure. FIG. 9 is a schematic bottom view illustrating the flow of air under the body 2 illustrated in FIG. 8. In FIG. 8, the spokes 22 and the rotor 30, which constitute the design of each wheel 6, are omitted. The design of the body 2 and the wheels 6 according to the present embodiment differs from that in FIG. 8.

Referring to FIG. 8, the body 2 of the vehicle 1 moves forward by rotating the four wheels 6 and the four tires 5 at the front left, front right, rear left, and rear right in the forward direction. In this case, the flow of air in the front-to-rear direction relative to the body 2 is generated around the body 2. The air hits the front surface of the body 2, and then splits in the up, down, left, and right directions into flows along the top, bottom, left and right surfaces of the body 2, which merge behind the body 2.

In the present embodiment, the rotor 30 and the stator 40 are provided in each of the four wheels 6 at the front left, front right, rear left, and rear right of the body 2. Each stator 40 includes the blocking plate 41 that blocks the internal space of the corresponding wheel 6, which is rotatable and exposed at the side surface 3 of the body 2 of the vehicle 1, from the inner side in the vehicle width direction of the body 2. This can reduce the outflow from the wheel 6 generated when the airflow under the body 2 flows outward from the side surface of the body 2 through the wheel 6 exposed at the side surface of the body 2.

Each rotor 30 includes the rotating vanes 34 arranged along the rim surface 25 of the rim 24 of the corresponding wheel 6. As illustrated in FIG. 6, when the wheel 6 rotates in the forward direction, the rotating vanes 34 radially push the air in front of the rotating vanes 34 in the rotation direction. The rotating vanes 34 cause the air in the central region of the internal space of the wheel 6 to flow toward the rim surface 25 of the wheel 6. As illustrated in FIGS. 3 and 4, the hollow cylinder 42 of the stator 40 is interposed between the rim surface 25 and the rotating vanes 34. The hollow cylinder 42 projects outward in the vehicle width direction from the blocking plate 41 of the stator 40, and has a surface continuous to the blocking plate 41. The hollow cylinder 42 projects outward in the vehicle width direction from the blocking plate 41 of the stator 40, and does not rotate together with the wheel 6.

Accordingly, the air pressure in a region outside the rotation trajectory of the rotating vanes 34 in the internal space of the wheel 6 may be higher than the air pressure in the other regions in the internal space of the wheel 6. As a result, airflow through the region outside the rotation trajectory of the rotating vanes 34 can be reduced. Since the blocking plate 41 and the hollow cylinder 42 of the stator 40 do not rotate together with the wheel 6, the gap 50 is to be provided between the stator 40 and each of the wheel 6 and the rotor 30 to prevent contact. However, airflow through the gap 50 can be reduced. The gap 50 provided to prevent contact is shaded in FIG. 4.

When the rotation of the rotor 30 increases, a mass of high-pressure air generated by the rotating vanes 34 overflows from the gap 50 between the hollow cylinder 42 of the stator 40 and the rotating vanes 34 of the rotor 30 along the surface of the stator 40. Since the internal space of the wheel 6 is surrounded by the surface of the stator 40, the mass of high-pressure air generated by the rotating vanes 34 can be expected to flow along the surface of the stator 40 toward the central region of the internal space of the wheel 6. When such an overflow occurs, the overall air pressure of the internal space of the wheel 6 can be expected to increase.

When the overall air pressure in the internal space of the wheel 6 increases so that the pressure difference between the region around the opening 44 of the exhaust nozzle 43 in the blocking plate 41 and the space under the body 2 is increased, a larger amount of airflow is discharged from the internal space of the wheel 6 through the exhaust nozzle 43. In the present embodiment, the under covers 7 and 9 and the large-capacity battery pack 8 are disposed at the bottom of the body 2 to form a flat surface, and the speed of the airflow under the body 2 is higher than that in a vehicle 1 in which the bottom of the body 2 is not covered with these flat components. As a result, the air pressure under the body 2 is reduced. In this case, the pressure difference is further increased. The air in the internal space of the wheel 6 is expected to be efficiently discharged to the space under the body 2 through the exhaust nozzle 43 as the rotor 30 rotates.

As illustrated in FIG. 9, each of the four wheels 6 at the front left, front right, rear left, and rear right is provided with the exhaust nozzle 43 projecting rearward under the body 2. In addition, as illustrated in FIG. 8, each of the four wheels 6 at the front left, front right, rear left, and rear right of the body 2 has the opening 44 of the exhaust nozzle 43 in the inner side thereof. The air in the internal space of each wheel 6 flows to the space under the body 2 through the exhaust nozzle 43.

Thus, the wheels 6 can suck in the air in the spaces outside the wheels 6. As represented by the dashed arrows in FIGS. 8 and 9, the outflow from the wheel spaces 4 in the spaces outside the wheels 6 can be easily sucked into the internal spaces of the wheels 6 (flow in). The outflow from the wheel spaces 4 does not easily serve as the outflow discharged outward in the vehicle width direction from the side surfaces 3 of the body 2 (blow out) as illustrated in FIGS. 1 and 2.

Additionally, as illustrated in FIG. 9, rearward airflow from each of the four exhaust nozzles 43 at the front left, front right, rear left, and rear right is added to the space under the body 2. The airflow under the body 2 easily flows rearward in the front-rear direction of the body 2. As a result, the bottom airflow under the body 2 quickly passes through the space under the body 2, and the intensity of the rearward flow is increased. As a result, the bottom airflow is not easily raised upward toward the rear surface of the body 2 in the space behind the body 2 after passing through the space under the body 2. The air resistance on the entire vehicle can be reduced.

According to the embodiment of the disclosure, the above-described improvements to the airflow can reduce the outflow discharged from the wheels 6 and the wheel spaces 4 to the space outside the body 2. As a result, the side airflow in the front-to-rear direction along the side surfaces 3 of the body 2 is not easily disrupted by the outflow from the wheels 6 and the wheel spaces 4, and can smoothly flow along the side surfaces 3 of the body 2 from the front of the body 2 toward the rear, as illustrated in FIGS. 8 and 9. Since the side airflow in the front-to-rear direction along the side surfaces 3 of the body 2 is not easily disrupted, the air resistance on the entire vehicle is reduced.

Additionally, in the embodiment of the disclosure, the rotors 30 are separate from the wheels 6. As a result, in the embodiment of the disclosure, the air resistance on the body 2 can be reduced by reducing the outflow from the wheels 6 without limiting the design of the wheels 6 and the body 2.

In the present embodiment, each rotor 30 includes the center member 31 capable of being placed on the inner side of the hub 21 of the wheel 6 and fastened to the body 2 together with the hub 21; the annular member 33 having an annular shape and disposed around the center member 31; and rod-shaped couplers 32 coupling the center member 31 to the annular member 33. The rotating vanes 34 are supported such that the rotating vanes 34 are arranged along the annular member 33 in the annular direction and extend in the vehicle width direction. Thus, the rotating vanes 34 of the rotor 30 are arranged along the rim surface 25 of the rim 24 of the wheel 6. When the wheel 6 rotates in the forward direction, the rotating vanes 34 rotate together with the wheel 6, thereby causing the air in the central region of the internal space of the wheel 6 to flow toward the rim surface 25. Airflow passing through the gap 50 (shaded in FIG. 4) between the hollow cylinder 42 of the stator 40 and the rim 24 of the wheel 6 is not easily generated.

In the present embodiment, the rotor 30 includes the center member 31 capable of being placed on the inner side of the hub 21 of the wheel 6 and fastened to the body 2 together with the hub 21. As a result, according to the present embodiment, the outflow from the wheel 6 can be reduced without affecting the design flexibility of the wheel 6 itself.

In the present embodiment, as illustrated in FIG. 4, the annular member 33 of the rotor 30 is in contact with the inner surface 23 of the wheel 6 along the entire circumference. Thus, the space around the hollow cylinder 42 of the stator 40 is separated from the space outside the wheel 6. The space around the hollow cylinder 42 of the stator 40 is filled with air supplied by the rotating vanes 34 that rotate together with the wheel 6, and the air around the hollow cylinder 42 does not easily flow out from the gap 50 between the annular member 33 and the inner surface 23 of the wheel 6. The air around the hollow cylinder 42 of the stator 40 does not serve as outflow from the wheel 6.

In the present embodiment, each rotating vane 34 of the rotor 30 extends in the tangential direction of the rotation circle along which the rotating vane 34 rotates together with the annular member 33. Thus, the air resistance on the rotating vanes 34 during rotation is reduced. When the rotor 30 rotates together with the wheel 6, the rotation of the rotor 30 does not impose a significant load on the rotation of the wheel 6. The wheel 6 can rotate under substantially the same amount of rotational load as that in the case where the present embodiment is not applied.

In contrast, if, for example, the entire outer surface of the wheel 6 has the shape of a screw, the screw serves to rotate air in the entire internal space of the wheel 6. The rotational load imposed by the screw is greater than that in the present embodiment.

In the present embodiment, the opening 44 of the exhaust nozzle 43 in the blocking plate 41 of the stator 40 is below the center of the wheel 6. Thus, the exhaust nozzle 43 can discharge the air in the internal space of the wheel 6 rearward into the space under the body 2 at a height at which airflow in the front-to-rear direction is present under the body 2. The air discharged from the exhaust nozzle 43 flows along the airflow in the front-to-rear direction under the body 2, and merges with the airflow in the front-to-rear direction under the body 2 without causing disturbances, thereby increasing the airflow in the front-to-rear direction under the body 2. This increases the intensity of the airflow under the body 2, so that the airflow is not easily raised upward after passing through the space under the body 2.

### Modifications

Although an exemplary embodiment of the disclosure is described above, the disclosure is not limited to this, and various modifications or alterations are possible without departing from the gist of the disclosure.

In the above-described embodiment, the rotating vanes 34 of the rotor 30 have a substantially rectangular shape and are supported by the annular member 33 in a cantilever manner.

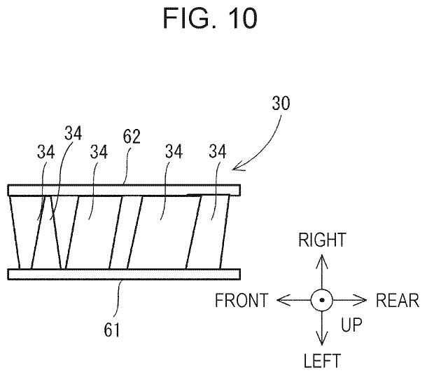

FIG. 10 is a schematic top view of a rotor 30 according to a modification of the embodiment of the disclosure.

The rotor 30 illustrated in FIG. 10 includes a center member 31, an outer annular member 61, couplers 32, rotating vanes 34, and an inner annular member 62.

Similarly to the structure illustrated in FIG. 6, the outer annular member 61 is concentrically coupled to the center member 31 with the couplers 32.

The inner annular member 62 has the same annular shape as that of the outer annular member 61. The rotating vanes 34 are coupled to the inner annular member 62 and the outer annular member 61. Since the rotating vanes 34 are coupled to the inner annular member 62 and the outer annular member 61, the rotating vanes 34 are not easily deformed even under a relatively large resistance during rotation.

The rotating vanes 34 illustrated in FIG. 10 are parallelogram-plate-shaped.

In the above-described embodiment, the center member 31 of the rotor 30 is coupled to the annular member 33 by the rod-shaped couplers 32.

Alternatively, for example, the center member 31 and the annular member 33 of the rotor 30 may be formed by stamping a single plate into a circular shape. In this case, multiple holes may be formed in a portion of the circular plate excluding central and peripheral portions of the circular plate. In this case, the portion in which the holes are formed serves as the couplers 32 that couple the center member 31 to the annular member 33.

The couplers 32 that couple the center member 31 to the annular member 33 may be rod-shaped as in the present embodiment. In this case, air can be appropriately introduced into the internal space of the wheel 6 from the space outside the wheel 6. The same amount of air as the amount of air discharged can be easily supplied to the internal space of the wheel 6. The air pressure in the internal space of the wheel 6 is not easily reduced due to insufficient supply of air.

In the above-described embodiment, when the wheel 6 is in a stationary state and not rotating, the annular member 33 of the rotor 30 is in contact with the inner surface 23 of the wheel 6 along the entire circumference, as illustrated in FIGS. 3 and 4.

Alternatively, in the stationary state, a small gap may be provided between the annular member 33 of the rotor 30 and the inner surface 23 of the wheel 6 along the entire circumference. Also in this case, when the wheel 6 rotates and the rotating vanes 34 receive air resistance, the annular member 33 of the rotor 30 may be bent to block the small gap and come into contact with the inner surface 23 of the wheel 6 along the entire circumference.

In the above-described embodiment, the couplers 32 of the rotor 30 are rod-shaped. The couplers 32 of the rotor 30 may have a shape other than the rod shape as long as the couplers 32 are shaped to couple the annular member 33 of the rotor 30 to the center member 31. The couplers 32 may be disposed at an angle relative to the rotational plane of the couplers 32 and shaped to cause air in the space outside the rotor 30 to flow into the space inside the rotor 30.

In the above-described embodiment, the annular member 33 of the rotor 30 is in contact with the inner surface 23 of the wheel 6 along the entire circumference in a region of the wheel 6 in which the substantially cylindrical rim 24 is coupled to the spokes 22. Thus, the space around the hollow cylinder 42 of the stator 40 shaded in FIG. 4 and the space outside the wheel 6 are separated from each other, so that airflow therebetween is not easily generated.

Alternatively, for example, the annular member 33 of the rotor 30 may be in contact with the rim surface 25, which is a portion of the inner surface 23 of the wheel, along the entire circumference. Also in this case, the annular member 33 can be in contact with the inner surface of the wheel 6 facing the internal space along the entire circumference. The annular member 33 can separate the space around the hollow cylinder 42 of the stator 40 from the space outside the wheel 6 so that airflow therebetween is not easily generated.

In the above-described embodiment, each rotating vane 34 is flat-plate-shaped and extends in the tangential direction of the rotation circle along which the rotating vane 34 rotates together with the annular member 33. The size, cross-sectional shape, and number of the rotating vanes 34 may be adjusted in accordance with, for example, the type of the vehicle 1.

Each rotating vane 34 may be at an angle relative to the tangential direction of the rotation circle along which the rotating vane 34 rotates together with the annular member 33. Thus, the amount of airflow in the radial directions generated by the rotating vanes 34 can be adjusted.

The rotating vanes 34 may be arranged on the annular member 33 over multiple turns instead of one turn along the rim surface 25 of the wheel 6. The rotating vanes 34 may have a different shape or extend at a different angle relative to the tangential direction in each turn.

In the above-described embodiment, the blocking plate 41 of each stator 40 has one exhaust nozzle 43.

Alternatively, for example, multiple exhaust nozzles 43 may be provided on one blocking plate 41.

According to an embodiment of the disclosure, a vehicle includes a stator including a blocking plate that blocks the internal space of a rim of a wheel provided in a wheel space that opens in a side surface of a body of the vehicle. This can reduce outflow from the wheel generated when air under the body flows outward from the side surface of the body through the wheel exposed at the side surface of the body.

A rotor rotatable with the wheel is provided in the internal space of the rim of the wheel. The rotor includes rotating vanes arranged along a rim surface of the rim of the wheel, and rotates together with the wheel to cause air in the central region of the wheel to flow toward the rim surface. The stator includes a hollow cylinder interposed between the rim surface and the rotating vanes. The hollow cylinder projects outward in the vehicle width direction from the blocking plate of the stator, and defines a surface continuous to the blocking plate. An exhaust nozzle has an opening in the blocking plate. Thus, the air caused to flow from the central region of the wheel toward the rim surface by the rotating vanes of the rotor can flow along the surface of the stator and be discharged to the space under the body through the exhaust nozzle that opens in the blocking plate. The exhaust nozzle is provided on the inner surface of the blocking plate in the vehicle width direction and extends rearward relative to the body.

Thus, the air in the internal space of the wheel can be discharged to the space under the body through the exhaust nozzle. The rearward airflow from the exhaust nozzle is expected to increase the intensity of the rearward airflow under the body, so that the airflow under the body is not easily raised upward toward the rear surface of the body after quickly passing through the space under the body. Additionally, since the outflow from the wheel is reduced, the airflow in the front-to-rear direction along the side surface of the body is not easily disrupted by the outflow, and is expected to flow smoothly along the side surface of the body. The air resistance on the vehicle can be reduced by the combination of the above-described effects.

In one embodiment of the disclosure, the rotor is separate from the wheel. As a result, according to the embodiment of the disclosure, the air resistance on the body can be reduced by reducing the outflow from the wheel without limiting the design of the wheel and the body.

1. A vehicle comprising:
a wheel provided in a wheel space that opens in a side surface of a body of the vehicle, the wheel being rotatable;
a rotor provided in an internal space of a rim of the wheel, the rotor being rotatable with the wheel; and
a stator comprising a blocking plate configured to block the internal space,
wherein the rotor comprises
a plurality of rotating vanes arranged along a rim surface of the rim, the rotating vanes causing air in a central region of the wheel to flow toward the rim surface when the wheel rotates in a forward direction, and
wherein the stator comprises
a hollow cylinder projecting outward in a vehicle width direction from the blocking plate and interposed between the rim surface and the rotating vanes, and
an exhaust nozzle having an opening in the blocking plate, the exhaust nozzle being disposed on an inner surface of the blocking plate in the vehicle width direction and extending rearward relative to the body from the opening.

2. The vehicle according to claim 1,
wherein the rotor comprises
a center member placed on an inner side of a hub of the wheel and attached to the body,
an annular member having an annular shape and disposed around the center member, and
couplers configured to couple the center member to the annular member, and
wherein the rotating vanes are supported such that the rotating vanes are arranged along the annular member in an annular direction.

3. The vehicle according to claim 2, wherein the annular member is in contact with an inner surface of the wheel along an entire circumference, the inner surface of the wheel facing the internal space.

4. The vehicle according to claim 2,
wherein each rotating vane extends in a tangential direction of a rotation circle along which the rotating vane rotates together with the annular member.

5. The vehicle according to claim 3,
wherein each rotating vane extends in a tangential direction of a rotation circle along which the rotating vane rotates together with the annular member.

6. The vehicle according to claim 4,
Wherein the opening of the exhaust nozzle in the blocking plate is located below a center of the wheel.

7. The vehicle according to claim 5,
Wherein the opening of the exhaust nozzle in the blocking plate is located below a center of the wheel.
